(19) United States
(12) Patent Application Publication
(10) Pub. No.: US 2012/0262113 A1
(43) Pub. Date: Oct. 18, 2012

(54) CHARGING APPARATUS OF MOBILE VEHICLE

(76) Inventor: Chang-Jyi SHEU, Taipei (TW)

(21) Appl. No.: 13/243,735

(22) Filed: Sep. 23, 2011

(30) Foreign Application Priority Data
Apr. 12, 2011 (TW) 100112559

(51) Int. Cl. H02J 7/00

(52) U.S. Cl. 320/109

(57) ABSTRACT

A charging apparatus of a mobile vehicle is provided to receive and convert an alternating current (AC) input source into a direct current (DC) input source for charging a rechargeable battery of the mobile vehicle. The charging apparatus includes an electromagnetic interference (EMI) filter, a power factor corrector (PFC), a DC/DC converter, and a voltage control unit.

The EMI filter receives the AC input source and eliminates the noise in the AC input source to prevent the conductive electromagnetic interference. The PFC is electrically connected to the EMI filter to convert the filtered AC input source into a first DC voltage and to improve the power factor of the first DC voltage. The DC/DC converter is electrically connected to the PFC to receive the first DC voltage and provide the required charging voltage for the rechargeable battery.

### BACKGROUND OF THE INVENTION

1. Field of the Invention

The present invention relates generally to a charging apparatus, and more particularly to a charging apparatus of a mobile vehicle.

2. Description of Prior Art

For today's technologies of driving mobile vehicles, that will be developed toward the trend of pollution-free and high-efficiency purposes. The battery is usually used to store the desired energy for the electric vehicles. In particular, the various generated energies, such as coal-fire energy, hydraulic energy, wind energy, thermal energy, solar energy, and nuclear energy, have to be converted into the electrical energy so that the electrical energy can be stored in the battery. However, the major issues of security, efficiency, and convenience have to be concerned during the energy conversion process.

In general, the conventional power supply is provided to receive and convert an external AC input power into a DC power through a power factor corrector, and then a DC/DC converter is used to provide the required charging voltage level of a rechargeable battery. In a practical application, the output voltage of the power factor corrector is fixed. Because the output voltage of the power factor corrector is related to the specification and topology thereof, the output voltage is fixed as soon as the specification and topology of the power factor corrector is determined. Accordingly, the charging voltage provided from the conventional power supply is limited and cannot be flexibly adjusted. Also, a range of the output voltage of the rear-stage DC/DC converter is significantly limited, thus reducing the conversion efficiency of the DC/DC converter and the overall charging efficiency of the power supply.

Accordingly, it is desirable to provide a charging apparatus of a mobile vehicle to provide the optimal conversion efficiency of a DC/DC converter and optimal charging efficiency of the charging apparatus by adjusting the output voltage of the power factor corrector.

### SUMMARY OF THE INVENTION

In order to solve the above-mentioned problems, a charging apparatus of a mobile vehicle is disclosed. The charging apparatus receives and converts an AC input power source into a DC output power source for providing a required charging voltage and a required charging current of a rechargeable battery of the mobile vehicle. The charging apparatus of the mobile vehicle includes an electromagnetic interference filter, a power factor corrector, a DC/DC converter, and a voltage control unit.

The electromagnetic interference filter receives the AC input power source to eliminate the noise in the AC input power source to produce a filtered AC power source. The power factor corrector is electrically connected to the electromagnetic interference filter to convert the filtered AC power source and output a first DC voltage. The DC/DC converter is electrically connected to the power factor corrector to receive the first DC voltage to provide the required charging voltage of the rechargeable battery. The voltage control unit is electrically connected to the DC/DC converter and the rechargeable battery to adjust the first DC voltage to be substantially equivalent to the charging voltage of the rechargeable battery, thus optimizing a conversion efficiency of the DC/DC converter.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a block diagram of a charging apparatus of a mobile vehicle according to the present invention;

FIG. 2 is a schematic curve chart of a charging voltage of a rechargeable battery according to the present invention;

FIG. 3 is a block diagram of a power factor corrector according to the one embodiment of the present invention; and

FIG. 4 is a block diagram of the power factor corrector according to another embodiment of the present invention.

### DETAILED DESCRIPTION OF THE INVENTION

Reference will now be made to the drawing figures to describe the present invention in detail.

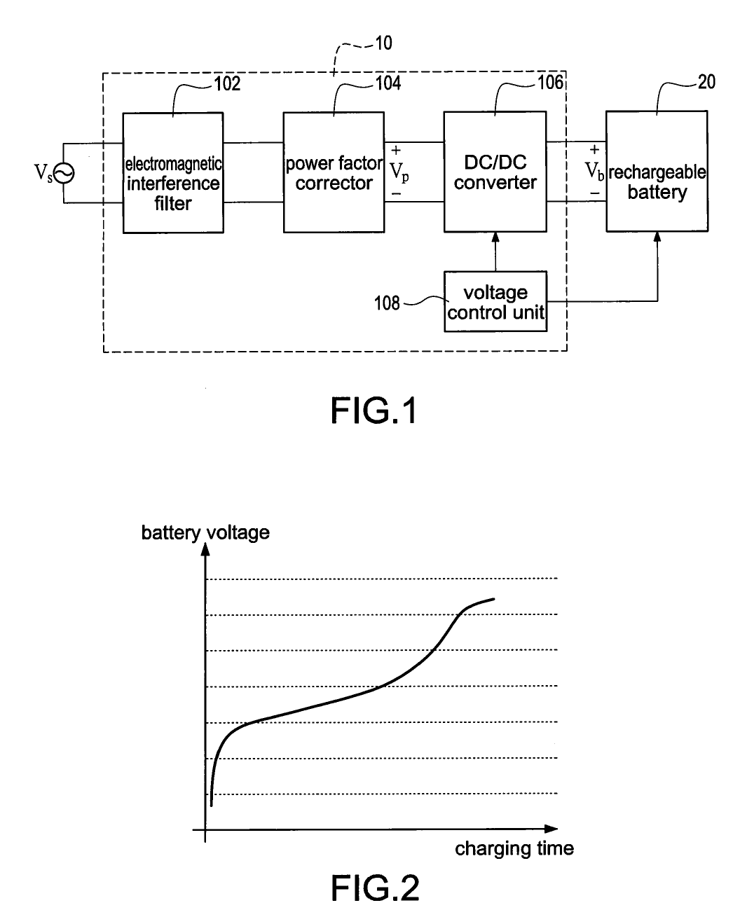

Reference is made to FIG. 1 which is a block diagram of a charging apparatus of a mobile vehicle according to the present invention. The charging apparatus 10 of the mobile vehicle receives and converters an AC input power source Vs into a DC output power source for providing a required charging voltage and a charging current of a rechargeable battery 20 of the mobile vehicle. The charging apparatus 10 of the mobile vehicle includes an electromagnetic interference filter 102, a power factor corrector 104, a DC/DC converter 106, and a voltage control unit 108. In particular, the charging apparatus 10 can be installed inside the mobile vehicle, also installed outside the mobile vehicle. The mobile vehicle can be an electric vehicle or an electric motorcycle, and the rechargeable battery 20 is a rechargeable battery of the electric vehicle or the electric motorcycle.

The electromagnetic interference filter 102 receives the AC input power source Vs to eliminate the noise in the AC input power source Vs to produce a filtered AC power source. The power factor corrector 104 is electrically connected to the electromagnetic interference filter 102 to convert the filtered AC power source and output a first DC voltage Vp. In particular, the power factor corrector 104 can be a boost converter, a buck converter, a buck-boost converter, an integrated buck/boost converter, a Cuk converter, or a single ended primary inductor converter (SEPIC). Also, the power factor corrector 104 can be a bridgeless power factor corrector (bridgeless PFC). Hence, the power factor corrector 104 can provide both step-up and step-down operations to acquire a wide range of the output voltage of the power factor corrector 104.

The DC/DC converter 106 is electrically connected to the power factor corrector 104 to receive the first DC voltage Vp to provide the required charging voltage of the rechargeable battery 20. In particular, the DC/DC converter 106 can be a buck converter. The voltage control unit 108 is electrically connected to the DC/DC converter 106 and the rechargeable battery 20 to adjust the first DC voltage Vp.

In general, the first DC voltage Vp of the power factor corrector 104 is a high-voltage DC voltage, typically is about 400 volts. Hence, the DC/DC converter 106, which is a buck converter, is provided to step down the first DC voltage Vp. Especially to deserve to be mentioned, the highest efficiency of the DC/DC converter 106 (buck converter) is ideally achieved when the input voltage of the DC/DC converter 106 is equal to the output voltage thereof. Because of nonideal circuit components, however, the highest efficiency of the DC/DC converter 106 is usually achieved when the input voltage of the DC/DC converter 106 is substantially equivalent to the output voltage thereof. Accordingly, the voltage control unit 108 is provided to adjust the first DC voltage Vp (namely, the input voltage of the buck converter 106) according to the output voltage of the buck converter 106 (namely, the battery voltage Vb of the rechargeable battery 20) when the rechargeable battery 20 is charged through the charging apparatus 10. The power factor corrector 104 can provide both step-up and step-down operations to acquire a wide range of the output voltage thereof. Hence, the first DC voltage Vp (namely, the output voltage of the power factor corrector 104) can be adjusted through the voltage control unit 108 to according to the different specifications and topologies of the power factor corrector 104. Although the highest efficiency of the DC/DC converter 106 can be achieved, the highest overall charging efficiency of the charging apparatus 10 can also be achieved by further adjusting the input voltage Vp when the conversion efficiency of the DC/DC converter 106 is optimal. That is, if the overall charging efficiency of the charging apparatus 10 is not optimal when the conversion efficiency of the DC/DC converter 106 is optimal, the input voltage Vp can be adjusted again to obtain the highest overall charging efficiency of the charging apparatus 10.

Reference is made to FIG. 2 which is a schematic curve chart of a charging voltage of a rechargeable battery according to the present invention. In a practical operation, the battery voltage Vb of the rechargeable battery 20 is not linearly increased during a charging process because a charging curve of the battery voltage Vb of the rechargeable battery 20 is nonlinear.

Hence, the input voltage Vp of the DC/DC converter 106 is adjusted to follow the battery voltage Vb of the rechargeable battery 20 so that the highest efficiency of the DC/DC converter 106 is achieved when the input voltage Vp of the DC/DC converter 106 is substantially equivalent to the battery voltage Vb of the rechargeable battery 20.

Furthermore, if an overall charging efficiency of the charging apparatus 10 is optimal when the conversion efficiency of the DC/DC converter 106 is optimal (namely, the highest efficiency is achieved), the input voltage Vp of the DC/DC converter 106 is maintained (not adjusted). On the other hand, if the overall charging efficiency of the charging apparatus 10 is not optimal when the conversion efficiency of the DC/DC converter 106 is optimal, the input voltage Vp is adjusted again to obtain the highest overall charging efficiency of the charging apparatus 10.

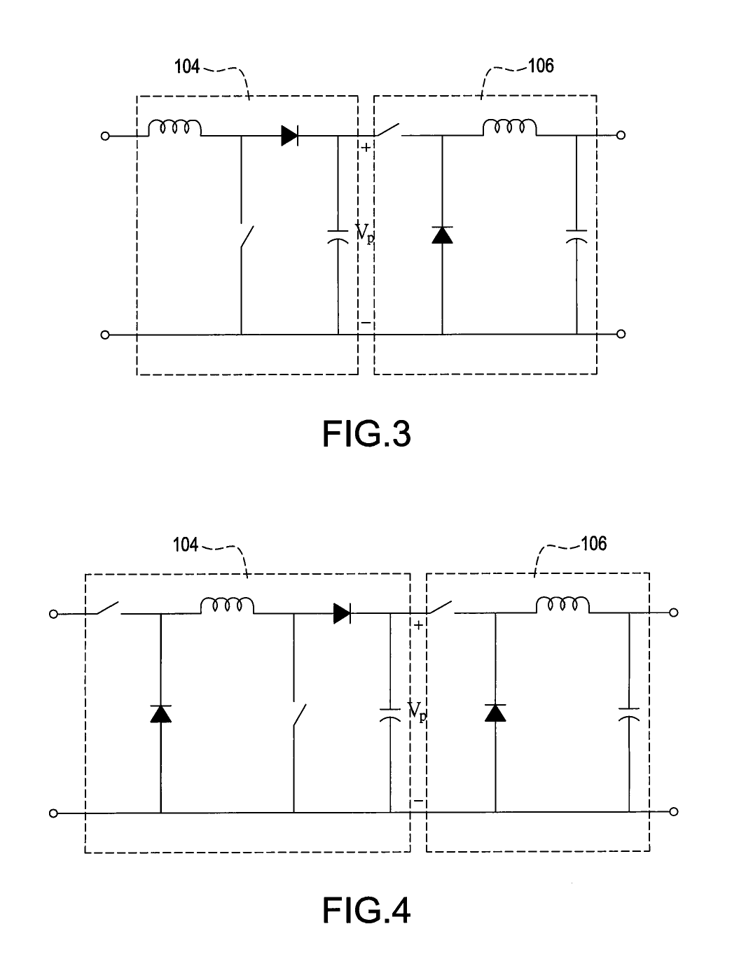

Reference is made to FIG. 3 and FIG. 4 which are block diagrams of the power factor corrector according to the one embodiment and another embodiment of the present invention. As shown in FIG. 3, the power factor corrector 104 is a boost converter. In this embodiment, the power factor corrector 104 converts the filtered AC power source and outputs the first DC voltage Vp, thus providing the power factor correction (PFC) operation.

As shown in FIG. 4, the power factor corrector 104 is an integrated buck/boost converter. The integrated buck/boost converter 104 has two switches (not labeled), two diodes (not labeled), an inductor (not labeled), and a capacitor (not labeled). The integrated buck and boost topology provides both step-up and step-down functions. In this embodiment, the power factor corrector 104 converts the filtered AC power source and outputs the first DC voltage Vp, thus providing the power factor correction (PFC) operation.

As mentioned above, the power factor corrector 104 is not limited to the above two embodiments, further can be a buck-boost converter, a buck converter, a Cuk converter, a single ended primary inductor converter (SEPIC), or a bridgeless power factor corrector (bridgeless PFC).

In conclusion, the present invention has following advantages:

1. The input voltage of the DC/DC converter 106 can be adjusted to optimize a conversion efficiency of the DC/DC converter 106; and

2. The input voltage of the DC/DC converter 106 can be adjusted to optimize an overall charging efficiency of the charging apparatus 10.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A charging apparatus of a mobile vehicle receiving and converting an AC input power source into a DC output power source for providing a required charging voltage and a required charging current of a rechargeable battery of the mobile vehicle; the charging apparatus of the mobile vehicle comprising:
an electromagnetic interference filter receiving the AC input power source to eliminate noise in the AC input power source to produce a filtered AC power source;
a power factor corrector electrically connected to the electromagnetic interference filter to convert the filtered AC power source and output a first DC voltage;
a DC/DC converter electrically connected to the power factor corrector to receive the first DC voltage to provide the required charging voltage of the rechargeable battery; and
a voltage control unit electrically connected to the DC/DC converter and the rechargeable battery to adjust the first DC voltage to be substantially equivalent to the charging voltage of the rechargeable battery, thus optimizing a conversion efficiency of the DC/DC converter.

2. The charging apparatus of claim 1, wherein the voltage control unit is configured to adjust the first DC voltage to optimize an overall charging efficiency of the charging apparatus when the conversion efficiency of the DC/DC converter is optimal.

3. The charging apparatus of claim 1, wherein the power factor corrector is a boost converter, a buck converter, a buck-boost converter, an integrated buck/boost converter, a Cuk converter, or a single ended primary inductor converter (SEPIC).

4. The charging apparatus of claim 1, wherein the power factor corrector is a bridgeless power factor corrector (bridgeless PFC).

5. The charging apparatus of claim 1, wherein the DC/DC converter is a buck converter.

6. The charging apparatus of claim 1, wherein the charging apparatus is installed inside the mobile vehicle.

7. The charging apparatus of claim 1, wherein the charging apparatus is installed outside the mobile vehicle.
